(19) United States
(12) Patent Application Publication
(10) Pub. No.: US 2010/0214373 A1
(43) Pub. Date: Aug. 26, 2010

(54) AUTHENTICATING A PRODUCT

(75) Inventors: Paul Carr, Yorkshire (GB); Ian Eastwood, Lancashire (GB); Paul Francis Mahon, Yorkshire (GB)

Correspondence Address: Matheson/ Keys PLLC, 7004 Bee Cave Rd., Austin, TX, 78746, US

(73) Assignee: AUTHENTIX, INC., Addison, TX (US)

(21) Appl. No.: 12/670,928

(22) PCT Filed: Aug. 2, 2007
(86) PCT No.: PCT/US07/75097

§ 371 Date: Jan. 27, 2010

(51) Int. Cl. B41J 2/02; G06K 7/10; G01N 21/55; C09D 11/02

(52) U.S. Cl. 347/73; 235/462.01; 356/448; 106/31.13

(57) ABSTRACT

This invention generally relates to a composition, an apparatus, and a method for authenticating a product. In particular, the invention relates to an ink composition for marking a product with a continuous inkjet printer. The composition includes a visible ink and a UV, visible, and/or IR marker. Marking includes depositing the ink composition on the product with the continuous inkjet printer. A marked product is authenticated with a hand-held apparatus that activates the marker in the mark with UV radiation. Activation of the marker in the mark changes the absorbance/reflectance of visible radiation by the mark without changing the visual appearance of the mark. Authenticity of the product is assessed by a change in absorbance or reflectance of visible radiation by the mark after activation of the mark.

### FIELD OF THE INVENTION

This invention generally relates to a composition, an apparatus, and a method for authenticating a product. In particular, the invention relates to an ink composition for marking a product with a continuous inkjet printer.

### BACKGROUND OF THE INVENTION

Counterfeit products may pose significant health, safety, and economic consequences. An increased emphasis on authentication of products requires sophisticated methods that are compatible with rapid production processes and not easily detected or duplicated by counterfeiters. At the same time, product authenticity should be reliable and easily verified by wholesale or retail suppliers.

U.S. Pat. No. 7,079,230 issued to McInerney et al., entitled “PORTABLE AUTHENTICATION DEVICE AND METHOD OF AUTHENTICATING PRODUCTS OR PRODUCT PACKAGING,” and U.S. Pat. No. 7,125,944 issued to Selinfreund et al., entitled “PRODUCT PACKAGING INCLUDING DIGITAL DATA,” describe methods of authenticating products and/or product packaging with light-sensitive materials.

Continuous inkjet printing of product packaging is rapid and cost-effective. However, it has been difficult to incorporate markers such as radiation-absorbing compounds in fast-drying inkjet ink. Furthermore, some radiation-absorbing compounds tend to destabilize irreversibly in inkjet formulations. An ink composition suitable for inkjet printers that allows problem-free production and rapid assessment of authenticity is desirable.

### SUMMARY

In another aspect, the invention features a method of marking a product. The method includes printing a mark on a product by depositing an ink composition with a continuous inkjet printer. The ink composition includes a visible ink and a marker mixed with the visible ink to form the ink composition. The marker is stable in the ink composition, and is capable of being activated to an activated state after deposition of the ink composition onto the product by continuous inkjet printing, where the activated state has a half-life in the deposited ink composition of at most about 5 seconds. The marker in the deposited ink composition in the activated state has a reflectance of visible radiation that is measurably different than the reflectance of visible radiation of the marker in the deposited ink composition that is not activated; and the measurable change is not visually detectable by the human eye. The marker may be a visible marker, a UV marker, or an IR marker.

In another aspect, the invention features a method of assessing authenticity of a product. The method includes selecting a product with a mark, assessing a first reflectance of a mark, activating the mark, assessing a second reflectance of the mark, and comparing the first reflectance with the second reflectance.

Implementations of the invention can include one or more of the following features. The mark may include a visible ink and a visible marker. The mark may include a visible ink and a UV marker. The mark may include a visible ink and an IR marker. Activating the mark includes irradiating the mark with electromagnetic radiation. Activating the mark may include irradiating the mark with white light or with UV radiation. Activating the mark does not induce a visible change in the mark. The first reflectance may be greater than the second reflectance. The first and second reflectance may be assessed with a hand-held instrument.

In another aspect, the invention features a method of assessing authenticity of a product. The method includes selecting a product with a mark, irradiating the mark with visible radiation, assessing a first absorbance of visible radiation by the mark, activating the mark, irradiating the mark with visible radiation, assessing a second absorbance of visible radiation by the mark, and assessing the authenticity of the product by comparing the first absorbance with the second absorbance. The mark may include a visible ink and a marker.

In another aspect, the invention features a method of assessing authenticity of a product. The method includes selecting a product with a mark, irradiating the mark with visible radiation, assessing a first reflectance of visible radiation by the mark, activating the mark printed on the product, irradiating the mark with visible radiation, assessing a second reflectance of visible radiation by the mark, allowing time to elapse, irradiating the mark with visible radiation, assessing a third reflectance of visible radiation by the mark, comparing the reflectance of visible radiation by the mark as a function of elapsed time with an expected reflectance as a function of elapsed time for an authentic product.

Implementations of the invention can include one or more of the following features. The mark may be a bar code, a portion of a label, and/or a logo Activating may include irradiating with visible, UV, or IR radiation

In another aspect, the invention features a method including the steps of selecting a product, depositing an ink composition on at least a portion of the product with a continuous inkjet printer, assessing a first reflectance of a mark, activating the mark, assessing a second reflectance of the mark, and comparing the first reflectance with the second reflectance. The ink composition includes a visible ink and a marker. Activating the mark may include irradiating the mark with visible, UV, or IR radiation.

In another aspect, the invention features a hand-held apparatus for authenticating a product. The apparatus includes a source of visible radiation and a detector. The detector is configured to assess an amount of visible radiation reflected by a mark on a product before and after activation of the mark. A difference between the amount of visible radiation reflected by the mark before activation of the mark and the amount of visible radiation reflected by the mark after activation of the mark allows assessment of the authenticity of the product. The light source may be a white light source.

In another aspect, the invention features a hand-held apparatus for authenticating a product. The apparatus includes a visible light source and a detector. The detector is configured to assess an amount of visible radiation absorbed by a mark on the product before and after activation of the mark. A difference between the amount of visible radiation absorbed by the mark before activation of the mark and the amount of visible radiation absorbed by the mark after activation of the mark is an indication of the authenticity of the mark. The light source may be a white light source.

In further embodiments, features from specific embodiments may be combined with features from other embodiments. For example, features from one embodiment may be combined with features from any of the other embodiments. In further embodiments, additional features may be added to the specific embodiments described herein.

### DETAILED DESCRIPTION OF THE DRAWINGS

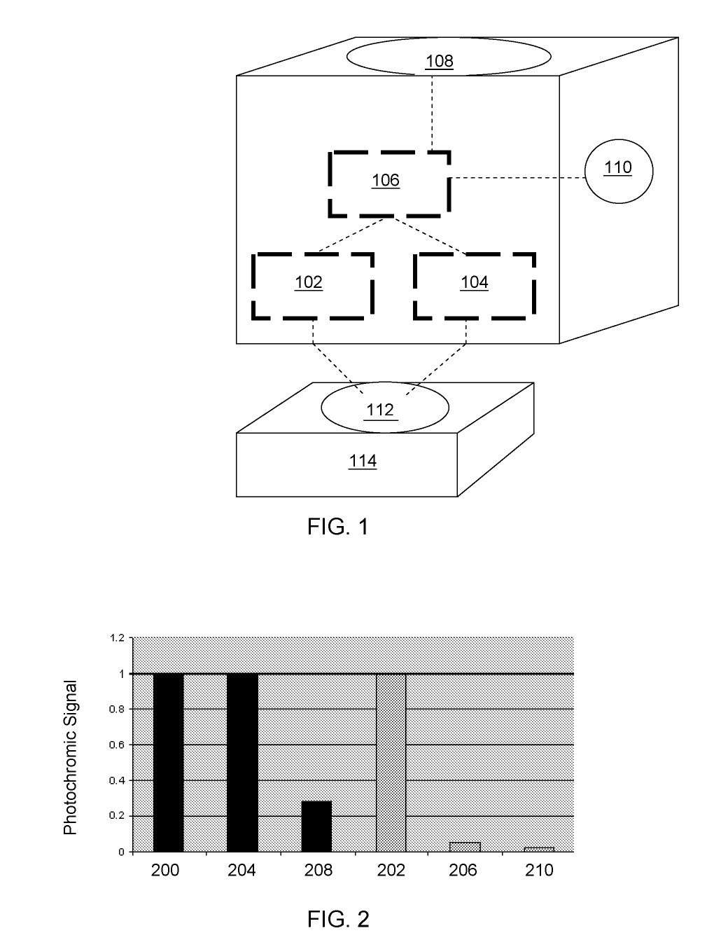

FIG. 1 is a schematic diagram of an instrument used to assess the authenticity of a mark.

FIG. 2 is a bar graph showing photochromic stability of a photochromic black ink and an uncolored analog.

Like reference numbers denote like elements.

### DETAILED DESCRIPTION

The following terms shall have the definitions given below when used in either lower case or with capitalizations in this specification:

As used herein, “activation” of a mark with a radiation-absorbing compound generally refers to exposing the mark or the marker to electromagnetic radiation that causes the absorbance or reflectance of the marker to change at a given wavelength or wavelength range.

As used herein, “authenticate” generally refers to confirm a product or commodity as genuine or substantially unadulterated or to confirm an origin or intended use of a product or commodity.

As used herein, “ink composition” generally refers to an ink known in the art to be used for continuous inkjet printing with one or more markers. At least one of the markers may be a radiation-absorbing marker.

As used herein, “IR radiation” generally refers to electromagnetic radiation with wavelengths in the range from about 0.75 or 0.8 microns to about 1000 microns. “Near IR radiation” generally refers to electromagnetic radiation with wavelengths in the range from about 0.75 microns to about 1.5 or 3 microns.

As used herein, “mark” generally refers to a visible mark printed on a product or product packaging used to authenticate or identify a product by absorbing, reflecting, emitting, or otherwise altering electromagnetic radiation incident on the mark. A mark generally includes one or more markers that respond to incident electromagnetic radiation so as to change in a physically measurable manner upon exposure to one or more wavelengths of light. A mark may be printed in various forms including, but not limited to, symbols, logos, lettering, bar codes, or combinations thereof.

As used herein, “marker” generally refers to a material used to authenticate or identify a product by absorbing incident electromagnetic radiation and responding to the incident electromagnetic radiation so as to change in a physically measurable manner, for instance, a change in reflectance or absorbance of a given wavelength or wavelength range. As used herein, marker generally refers to one or more markers. A “UV marker” generally refers to a chemical compound that undergoes a change in absorbance and reflectance of a portion of the electromagnetic spectrum upon exposure to UV radiation. A “visible marker” generally refers to a chemical compound that undergoes a change in color (and hence absorbance and reflectance of visible light) upon exposure to visible radiation. An “IR marker” generally refers to a chemical compound that undergoes a change in absorbance and reflectance of a portion of the electromagnetic spectrum upon exposure to IR radiation.

As used herein, “photochromic compound” generally refers to a chemical compound that changes in color when activated. Photochromic compounds may be activated by irradiation with visible radiation, near-visible UV or IR radiation, or in some cases UV radiation. The effect is generally reversible. A photochromic compound is a visible marker.

As used herein, “product” generally refers to a product or a portion of product packaging. In some embodiments, authentication of a product may include authentication of a mark on a portion of product packaging, such as a paper or plastic box, sleeve, or wrapper.

As used herein, “UV radiation” generally refers to electromagnetic radiation in the wavelength range of about 1 nm to about 400 nm.

As used herein, “visible radiation” generally refers to electromagnetic radiation in the wavelength range of about 400 nm to about 770 nm.

Continuous inkjet printing allows rapid labeling of products. However, high throughput in a production environment requires ink compositions used in continuous inkjet printers to dry quickly. Formulating an ink composition to include a marker requires careful selection of the marker such that the resulting ink composition is compatible with the printing apparatus and the substrate on which the ink composition is deposited. A desirable ink composition will not clog the printer and will dry quickly on a substrate (for instance, a product or product packaging). Furthermore, a marker in an inkjet ink composition is desirably light stable.

A marker in an inkjet ink composition deposited on a substrate (for instance, a product or product packaging) may be activated with electromagnetic irradiation. Activating a marker in a deposited ink composition may result in a change in reflectance or absorbance of electromagnetic radiation by the ink composition. A change in reflectance or absorbance of electromagnetic radiation (for instance, UV, visible, IR) by the ink composition may be measurable. At the same time, the change in reflectance or absorbance of electromagnetic radiation of the ink composition may not be visually detected by the human eye. It is also desirable that activation of a marker in an inkjet ink composition is reversible and that the marker has a short half-life in the activated state, returning to an unactivated state rapidly after activation.

Visible ink used in inkjet printers may be mixed with one or more markers to form an ink composition. In some embodiments, at least one of the markers is a radiation-absorbing compound. The marker may be activated by UV, visible, or IR radiation. Activation of a radiation-absorbing compound may induce a measurable change in absorbance or reflectance of a given wavelength or wavelength range. This measurable change may not be visually detectable. For instance, a photochromic compound may change in color upon activation from clear to black. If the photochromic compound is mixed with visible ink, such as black ink or gray ink, activation of the photochromic compound may cause a measurable change in absorbance or reflectance of a mark (a deposited ink composition), but not a visually detectable difference in the appearance of the mark. For instance, a photochromic compound in a gray ink may change from clear to black, increasing the absorbance of a mark without changing the visual appearance of the mark. A photochromic material that absorbs in the IR, near IR, or UV would be invisible to the eye both before and after activation.

A marker may be activated by UV, visible, or IR radiation. The marker may be colorless before and after activation (that is, in the activated state and the unactivated state). Such a marker may be mixed with visible ink in an inkjet ink composition. Activation of a mark with a UV, visible, or IR marker may result in a change in absorbance or reflectance of the mark at a given wavelength or wavelength range without a visually detectable change in the mark. In some embodiments, a visible inkjet ink (such as a black ink) may not absorb a certain portion of the electromagnetic spectrum (for instance, IR radiation). For instance, many black inks do not absorb in the IR, thus providing an opportunity to formulate a variety of desirable inks. In this case, a change in reflectance or absorbance of IR radiation after activation of a marker could be attributed to the presence of a marker and is not affected by the presence of the inkjet ink.

In an embodiment, an ink composition may be formulated by mixing visible ink and a photochromic compound. The photochromic compound may include, for example, one or more spiropyrans, spirooxazines, chromenes (benzo- and naphthopyrans), fulgides, diarylethenes, indolizine, and derivatives thereof.

Spiropyrans are generally colorless/pale yellow solids, and are photochromic in solution (e.g., gels, resins, films, bulk plastic solids), and become intensely colored upon UV irradiation. Certain spiropyran derivatives absorb in the infrared region, and are resistant to thermal fading and photobleaching with visible light in polar or non-polar solvents. The photochromic nature of spiropyrans is shown below:

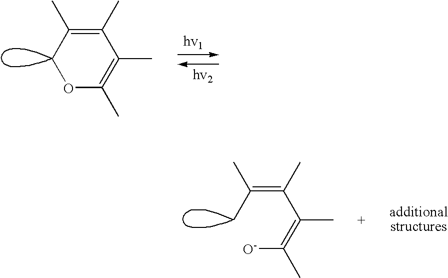

Spiropyrans may be synthesized by a condensation reaction, as shown below to form spiropyran BIPS (1′,3′,3′,-trimethylspiro-[-2H-1-benzopyran-2,3′-indoline].

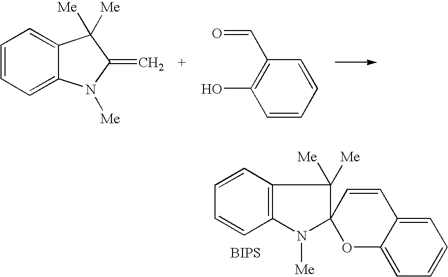

Photochromism of BIPS is depicted below:

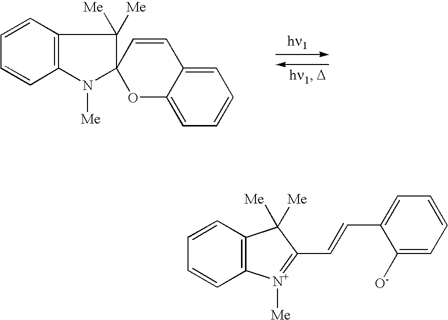

Becker et al. (R. S. Becker, J. Kolc, Photochromism: Spectroscopy and photochemistry of pyran and thiopyran derivaties, J. Phys. Chem., 72, 997 (1968)) found that replacing the pyran 0 with S to form spiro[2H-1-benzopyran-2,2′indoline] led to absorption in the infra-red region. While the 2-mercaptobenzaldehyde intermediate is difficult to synthesise, the 5-nitro derivative is readily available and can form spiropyrans that absorb above 800 nm (S. Arakawa, H. Kondo, J. Seto, Photochromism, Synthesis and properties of indolinospirobenzothiopyrans, Chem. Lett., 1985, 1805-1808).

Spiropyrans have been synthesized using heterocylic bases to produce dyes that absorb in the infrared region. The spiropyran shown below, made by the condensation of 2-phenyl-1,3,6-trimethyl-2-azulenium perchlorate with 5-nitrosalicylaldehyde, absorbs at 733 nm and 536 nm, and does not appear to thermally fade or photobleach with visible light in polar or non-polar solvents (R. C. Bertelson, unpublished).

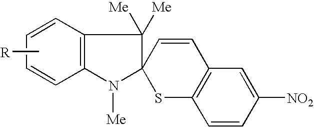

Photochromic spirooxazine compounds include a condensed ring substituted 2H-[1,4]oxazine in which the number 2 carbon of the oxazine ring is involved in a spiro linkage, as shown below. They are generally prepared by reacting a nitroso naphthol with a Fischer's base derivative in an organic solvent. The crude product then requires purification.

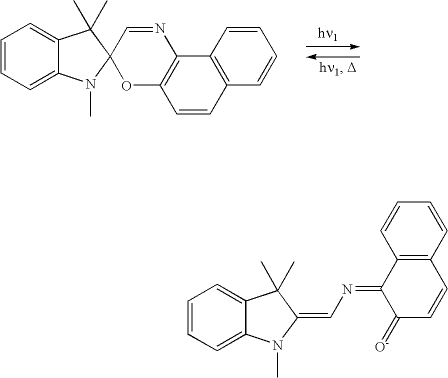

Photochromism of spirooxazines is attributed to the photochemical cleavage of the spiro-C—O bond, which results in the extension of π-conjugation of the colored photomerocyanine. These molecules have excellent resistance to light induced degradation (fatigue) due to the photochemical stability of oxazine molecule framework in both the ring closed and ring open form. The kinetics of the reverse decolorization are often temperature dependent.

By substituting the naphthoxazine ring at the 9 and 8 position, the photochromic response increases dramatically with little effect on the visible absorption band (U.S. Pat. No. 4,215,010. to Hovey et al.). The structure of 1,3,3-trimethylspiro[indoline-2,3′-[3H]naphtho[2,1-b][1,4]oxazine] (NISO), along with changes in optical density (ΔOD) for certain substitutions, are shown below.

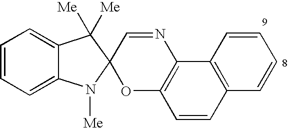

| Subs. on | |
|---|---|
| NISO | ΔOD |
| — | 0.9 |
| 9′-Methoxy | 1.4 |
| 9′-Ethoxy | 1.4 |
| 8′-Bromo | 1.2 |

U.S. Pat. No. 4,637,698 to Kwak et al. describes indolino spirooxazines derived from 5-nitro-6-hydroxyquinoline. These spiropyridobenzoxazines have greater sensitivities and equilibrium responses compared to spironaphthoxazines. PCT Publication No. WO 8,907,104 to Yamamoto et al. describes spirooxazines derived from hydroxynitrosodibenzofurans, shown below, with two absorption bands in the visible range.

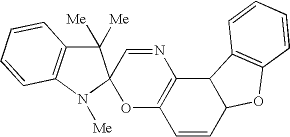

The above dye absorbs at 460 nm and 632 nm in methyl alcohol after UV irradiation, making it possible to produce neutral dye colors from one molecule.

Pepe et al. (G. Pepe, P. Lareginie, A. Samat, R. Guglielmetti, and E. Zaballos, Acta Cryst., C51, 1617-1619 (1995)). synthesized spiro azabicycloalkane-naphthoxazines with steric hindrance that lengthens the C—O bond and enhances the photochromic colorability.

Molecules containing two photochromic entities which are covalently linked have been described by Durr et al. as biphotochromic (H. Durr, H. Bous-Laurent, Eds.; Photochromism: Molecules and Systems; Elsevier: Amsterdam, 1990). These molecules can be linked by a non-conjugated chain (A), be annellated (B), or be linked by a conjugated chain (C).

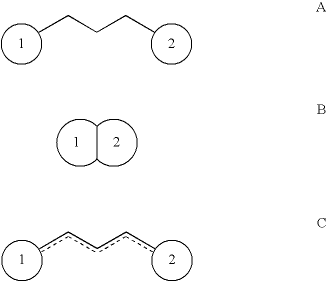

Samat et al. studied biphotochromics of spirooxazines and diarylnaphthopyrans linked by an ethylenic bond (A. Samat, V. Lokshin, K. Chamontin, D. Levi, G. Pepe, and R. Guglielmetti, Synthesis and unexpected photochemical behavior of biphotochromic systems involving spirooxazine and naphthopyrans linked by an ethylenic bridge, Tetrahedron 57 (2001) 7349-7359), as shown below. Photochromic behavior was evaluated under continuous Xenon lamp irradiation at room temperature with toluene as the solvent. The above molecule shows thermally reversible photochromic behavior which is comparable to model spirooxazines and chromenes. Coloration and fading of these molecules occurs in the order of seconds. Photobleaching of this compound leads to degradation.

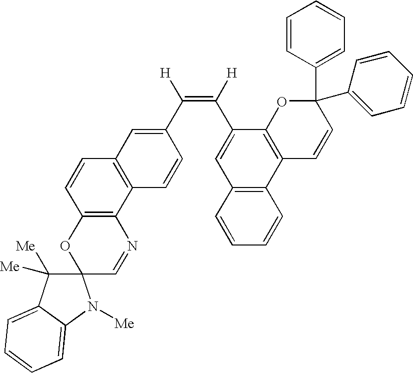

| λₘₐₓ | A_{∞} | k_{Δ}(s⁻¹) |
|---|---|---|
| 447 | 0.2 | 0.05 |
| 612 | 0.1 | 0.15 |

Favaro et al. also studied biphotochromic molecules including chromene and spirooxazine chromophores (G. Favaro, D. Levi, F. Ortica, A. Samat, R. Guglielmetti, and U. Mazzucato, Photokinetic behavior of bi-photochromic supramolecular systems Part 3: Compounds with chromene and spirooxazine units linked through ethane, ester and acetylene bridges, Journal of Photochemistry and Photobiology A: Chemistry 149 (2002) 91-100). In this case, the spacer unit is an ester linkage. Upon excitation with UV irradiation, two peaks occur in the visible region. This leads to the active form being a grey color. This molecule is only thermally reversible.

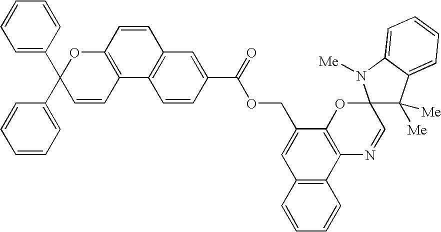

| | | |
|---|---|---|
| λₘₐₓ (nm) | 444 | 608 |
| λₑₓₑ (nm) | 337 | |
| εₘₐₓ (dm³mol⁻¹cm⁻¹) | 27500 | 40000 |
| φ | 0.20 | 0.09 |
| k_{Δ} (280) (s⁻¹) | 0.03 3 | 0.027 |
| k_{Δ} (298) (s⁻¹) | 0.17 | 0.18 |
| Eₐ (kJ mol⁻¹) | 66 | 69 |
| A (s⁻¹) | 7 × 10¹⁰ | 2 × 10¹¹ |

Photochromism of benzo- and naphthopyrans (chromenes) is attributed to breaking of the oxygen-carbon bond of the pyran, as shown below.

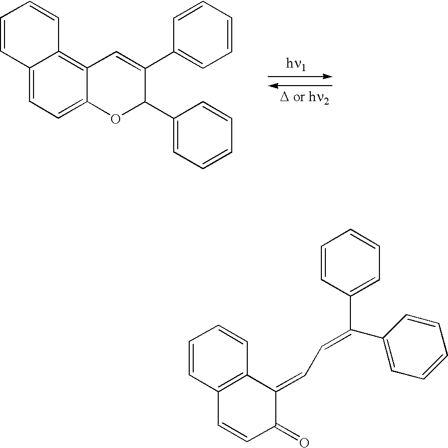

Two or more photochromic molecules may be mixed to achieve neutral colored dyes. Some benzo- and naphthopyrans have two absorption peaks in the visible spectrum, which result in neutral dyes. This “double peak” technology is implemented by, for instance, James Robinson, Ltd. (Huddersfield, England).

A 3H-naphtho[2,1-b]pyran is shown below. With R1 and R2 being hydrogen, photochromism is not reduced by steric inhibition of bond rotation or isomerization.

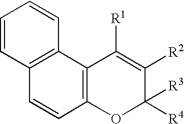

With R3 and/or R4 aryl, fatigue is improved. Substituents on the phenyl groups affect color, intensity and fade. With an electron donating group in the para position, a bathochromic shift is observed in the visible spectrum, with lower equilibrium and more rapid fade. Substitution at the meta position shows little effect. Substitution at the ortho position gives enhanced optical density and slows fade rate.

Eur. Pat. Appl. 0,629,620 A1 to Allegrini et al. describes substituted 3H-naphtho[2,1-b]pyrans containing a 3-aryl grouping and a 3-heteroaromatic group, as shown below, with spectroscopic data as indicated.

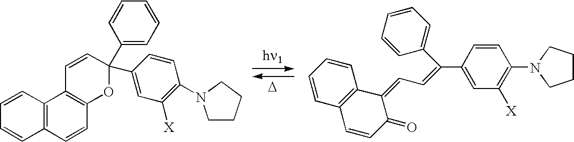

| X | λ_{MAX} (nm) | t_{1/2} (s) |
|---|---|---|
| I | 494 | 5 |
| Br | 493 | 4 |
| Cl | 513 | 4 |
| F | 529 | 4 |
| Me | 517 | 3 |
| OMe | 557 | 5 |
| H | 538 | 5 |

(Data from C. D. Gabbutt, B. M. Heron, A. C. Instone, P. N. Horton, M. B. Hursthouse., Synthesis and photochromic properties of substituted 3H-naphtho[2,1-b]pyrans, Tetrahedron 61 (2005) 463-471.)

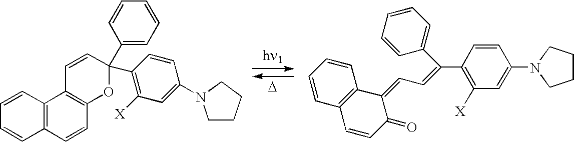

| X | λ_{MAX} (nm) | λ_{MAX} (nm) | t_{1/2} (s) |
|---|---|---|---|
| Cl | 403 | 480 | 44 |
| F | 394 | 501 | 21 |
| OMe | 399 | 519 | 73 |
| Me | 410 | 507 | 104 |
| H | 538 | — | 5 |

(Data from C. D. Gabbutt, B. M. Heron, A. C. Instone, The synthesis and electronic absorption spectra of 3-phenyl-3(4-pyrrolidino-2-substituted phenyl)-3H-naphtho[2,1-b]pyrans: further exploration of the ortho substituent effect, Tetrahedron 62 (2006) 737-745.)

These dyes give two absorption maxima leading to formation of neutral colored dyes.

Photochromic behavior of 2H-naphtho[1,2-b]pyrans is shown below.

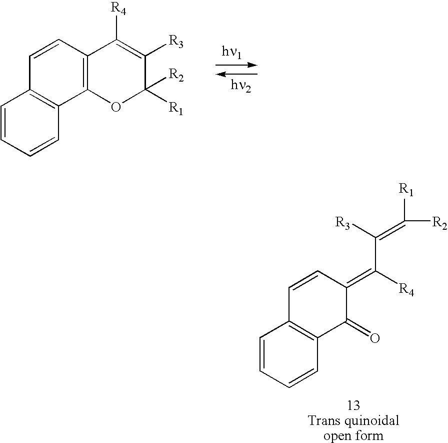

These molecules are bathochromically shifted, more intense, and slower to fade than isomeric 3H-naphtho[2,1-b]pyrans, due to less steric hindrance. Heller et al. describe 2H-naphtho[1,2-b]pyran with a spiro adamantylidene group at the 2 position in U.S. Pat. No. 4,826,977. Tanaka et al describe spiro bicycle[3,3,1]9-nonylidene in U.S. Pat. No. 5,349,065. Heller describes spiro 2-norbornanylidene in U.S. Pat. No. 4,980,089. Heller describes 2-cyclopropyl-2-aryl(and heteroaryl) substituents in U.S. Pat. Nos. 5,200,116 and 2,2-dicycylopropyl substituents in U.S. Pat. No. 4,931,221. Gemert et al. showed that 2 aryl group substituents produced an orange photochrome that faded slowly (B. Van Gemert, M. Bergomi, and D. Knowles, Photochromism of diarylnaphthopyrans, Mol. Crys. Liq. Crys., 67-73 (1994)).

In indeno fused naphthopyrans, shown below, the substituted or unsubstituted methylene bridge at the 5 position can be varied in size to give appropriate fade and intensity of the photochromic compound (U.S. Pat. No. 5,645,767 to Gemert). This also holds the phenyl group at the 6 position in plane with the naphthopyran, thus extending the chromophore. Due to increased steric hindrance, rapid fade rates are achieved.

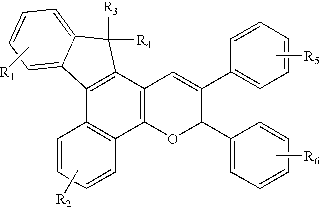

Brun et al. described naphthopyrans substituted at the 2 position with ferrocenyl, ruthencenyl and osmocenyl (P. Brun, R. Guglielmetti, and S. Anguille, Metallocenyl-[2H]naphtha[1,2-b]pyrans: metal effect on the photochromic behavior, Applied organometallic chemistry (2002) 16: 271-276). Substitution with ferrocenyl gives two absorption bands in visible spectrum compared to only one for both ruthencenyl and osmocenyl.

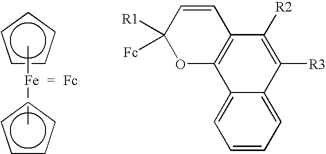

| Compound | R₁, R₂, R₃ | λₘₐₓ | k_{Δ}(s⁻¹⁾ |
|---|---|---|---|
| 1 | Me, H, H | 472 | 1.1 × 10⁻² |
| | | 609 | 4.2 × 10⁻³ |
| 2 | Ph, Me, Me | 470 | 2.3 × 10⁻² |
| | | 602 | 1.2 × 10⁻³ |

Recorded in acetonitrile.

Photochromism of 2H-naphtho[2,3-b]pyran is depicted below.

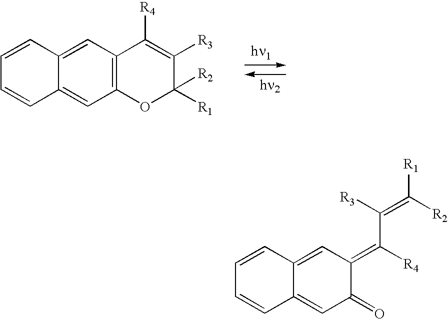

When R₁ and R₂ are phenyl substituted, these molecules may be photochromic only at low temperatures.

2H-1-benzopyrans (chromenes) are less photochromic than 3H-naphtho[2,1-b]pyrans and 2H-naphtho[1,2-b]pyrans with the same substituents. They are also more fatigue prone and less responsive to solar radiation due to UV absorption being at lower wavelengths than naphthopyrans.

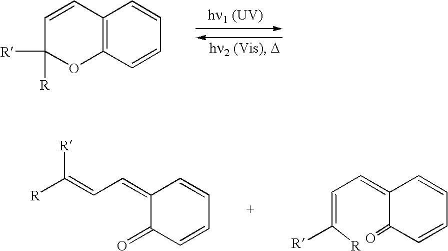

Heteroaromatic annellation -5,6 (or f-face) is described in Eur. Pat. Appl. 0,562,915 A1 to Guglielmetti et al. When the heteroaromatic group is a 6-membered ring, photochromic properties mimic the corresponding naphthopyran. When the heteroaromatic group is a 5-membered ring, properties are intermediate between naphtha- and benzopyran.

2H-1-benzopyrans with heteroaromatic groups annellated on the f-, g-, or h-face, shown below, are described in U.S. Pat. No. 5,411,679 to Kumar.

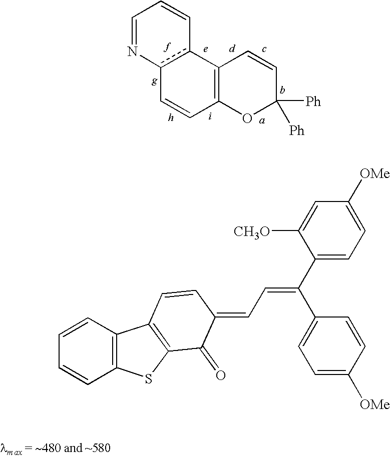

The colored form of many of these molecules have very broad, double maxima absorptions and exhibit enhanced optical density.

Eur. Pat. Appl. 0,676,401 A1 to Pozzo et al. describes heteroannellated 2H-1-benzopyrans with spirofluorene substituted for both phenyls at 2 position. U.S. Pat. No. 5,429,774 to Kumar describes substitution of benzothieno or benzofurano groups for one of the phenyls.

Fulgides are typically yellow or orange crystalline compounds which change to orange, red or blue upon exposure to UV light. As shown below, fulgides are derivatives of dimethylene succinic anhydrides.

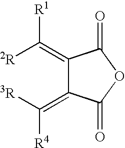

Fulgides substituted with four different groups R¹, R², R³ and R⁴ can exist in four geometrical isomers [(E,E), (E,Z), (Z,E), (Z,Z)]. At least one of R¹, R², R³ and R⁴ is generally aryl in photochromic fulgides. The carbonyl groups in conjugation with the double bonds are thought to be responsible for the color of the fulgides. Therefore, color changes can be bought about by changing substituents. Fulgides may undergo photochemical E-Z isomerization and sigmatropic proton shifts. As shown in the photochromic equilibrium below, when X═NR rather than 0, the resulting dye is a fulgimide.

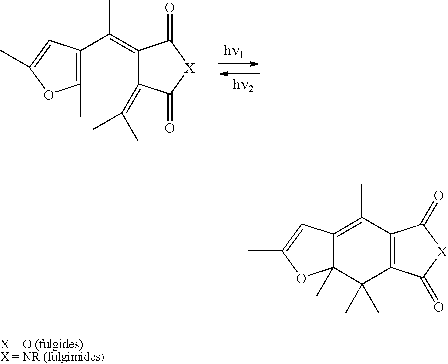

Phenyl fulgides cyclize to form 1,8a-dihydronaphthalene derivatives under UV irradiation, and return to original form under visible light. These compounds may have a low resistance to fatigue. A furyl fulgide is shown below.

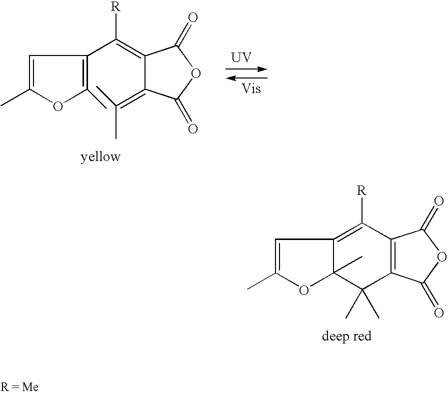

The quantum yield for open to closed form Φ_{E-C} in toluene is 0.20 and is substantially temperature independent between 10-40° C. (H. G. Heller and J. R. Langan, Photochromic heterocyclic fulgides. Part 3. The use of (E)-α-(2,5-dimethyl-3-furylethylidene) (isopropylidene) succinic anhydride as a simple convenient chemical actinometer, J. Chem. Soc., Perkin. Trans. 2, 1981, 341). Cycling between the forms does not appear to affect the quantum yield. By increasing the steric hindrance of the R group, the coloration quantum yield can be significantly increased, as shown below.

| R | φ_{E-C} |
|---|---|
| Me | 0.20 |
| Et | 0.34 |
| n-Pr | 0.45 |
| i-Pr | 0.62 |
| t-Bu | 0.79 |

Fulgides in PMMA films are know to undergo the following reaction (Y. Chen, C. Wang, M. Fan, B. Yao, and N. Menke, Photochromic fulgide for holographic recording, Optical Materials 26 (2004) 75-77 and Y. Chen, T. Li, M. Fan, X. Mai, H. Zhao, D. Xu, Photochromic fulgide for multi-level recording, Materials Science and Engineering B 123 (2005) 53-56).

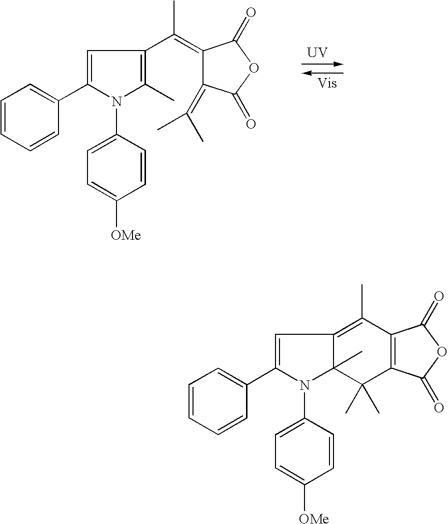

The above fulgide is pale yellow and changes to blue under UV irradiation. It is stable at room temperature in darkness. The fatigue was studied by a He—Ne laser and UV light. To activate the colored form took is under UV light; decoloration occurred in 3s with the He—Ne laser. Up to 450 cycles were performed without degradation.

The fulgide shown below has absorption peaks at 382 nm (open) and 820 nm (ring closed), and can cycle up to 300 times without degradation.

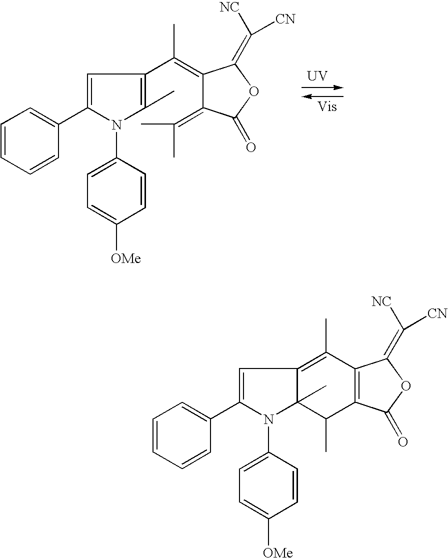

Diarylethenes with heterocyclic 5-membered rings as the aryl groups, such as thiophene or benzothiophene, undergo photochromic reactions that are thermally irreversible and have high fatigue resistance. This stability is attributed to aryl groups which have low aromatic stabilisation energies. 1,2-Diarylethenes with two thiophene derived groups undergo reversible electrocyclic interconversion between a conjugated closed (on) and unconjugated open (off) state under irradiation at well separated wavelengths with high quantum yields (S, Nakamura and M. Irie, J. Org. Chem., 1988, 53, 6136 and Y. Nakayama, K. Hayashi, M. Irie, J. Org. Chem., 1990 55, 2592). Perfluorocyclopentene derived molecules have a high resistance to photofatigue (M. Hanazawa, R. Sumiya, Y. Horikawa, M. Irie, J. Chem. Soc., Chem. Commun., 1992, 206).

Compounds 1 and 2, shown below, exhibit good photochromic properties with high resistance to fatigue (S. L. Gilat, S. H. Kawai, J. M. Lehn, Light triggered Electrical and Optical Switching devices, J. Chem. Soc., Chem. Commun., (1993) 1439).

Compound 1

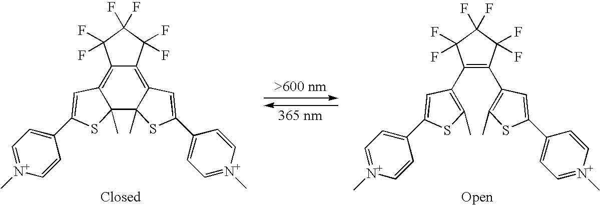

Compound 2

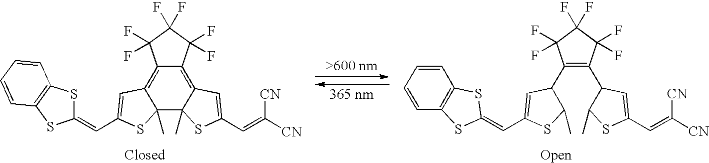

| Compound | λₘₐₓ /nm | Solvent | Conversion^{a} |
|---|---|---|---|
| 1 (open) | 352 | CD₃CN | >99.5 |
| closed | 662 | | |
| 2 (open) | 354 | C₆D₆ | >99.5 |
| (closed) | 828 | | |

^{a}to photostationary state for irradiation at 365 nm

Dihydroindolizines (DHIs) are colorless or slightly yellow thermochromic compounds that include a 5-membered ring—cyclopentene anion. Depending on substitution, the colored, betaine form with a butadienylvinylamine chromophore can absorb in almost all regions of the visible spectrum. The equilibrium below shows photochromism of spiro[1,8a]dihydroindolizines.

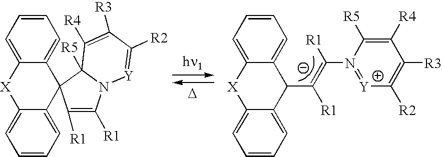

| | | | | | | | λₘₐₓ | λₘₐₓ | |
|---|---|---|---|---|---|---|---|---|---|
| X | R₁ | Y | R₂ | R₃ | R₄ | R₅ | DHI | Betaine | t_{1/2} |
| — | CO₂CH₃ | CH═CH— | | H | H | H | 360 | 470 | 0.123 |
| | | CH═CH | | | | | | | |
| — | AC/E | N | H | H | H | H | 402 | 529 | 36 |
| — | CO₂CH₃ | CH | H | H | H | H | 401 | 645 | 21.5 |

Depending on substitution, tetrahydroindolizines (THIS) can also absorb almost everywhere in visible region. The chromophore is an enamine unit and can exist in all colors. Various photochromic tetrahyrdoindolizines form zwittwerionic betaines under UV light (S. A. Ahmed, A. A. Abdel-Wahab, and H. Durr, Steric substituent effects of new photochromic tetrahydroindolizines leading to tunable photophysical behavior of the colored betaines, Journal of Photochemistry and Photobiology A: Chemistry 154 (2003) 131-144).

| Compound | λₘₐₓ THI/nm | λₘₐₓ Betaine/nm | t_{1/2} (s) | Color |
|---|---|---|---|---|
| 1 (H) | 327 | 480, 719 | 16.47 | Green |
| 2 (o-NO₂) | 340 | 485, 690 | 484.7 | Green-blue |
| 3 (o-Cl) | 328 | 480, 668 | 1851.80 | Blue |

Some photochromic 2,4,7-substituted fluorine-9′-styrylquinolinedihydroindolizines (DHIs), as shown below recorded in CH₂Cl₂ at 23° C., have absorption maxima in the visible region (450-525 nm), and some in the IR region (S. Ahmed, Photochromism of dihydroindolizines. Part II—Synthesis and photophysical properties of new photochromic IR-sensitive photoswitchable substituted fluorine-9′-styrylquinolinedihydroindolizines, J. Phys. Org. Chem. (2002) 15 392-402).

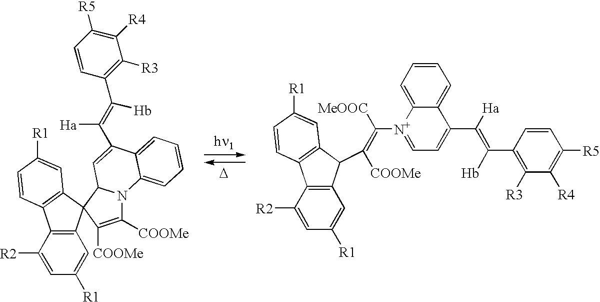

| | λₘₐₓ DHI | λmax Betaine | k × 10⁻³ | | |
|---|---|---|---|---|---|
| Compound | (nm) | (nm) | (s⁻¹) | t_{1/2} (ms) | Color of Betaine |
| 1 | 330; 365 | 475; 800 | 4.10 | 169 | Orange-brown |
| 2 | 335; 367 | 475; 800 | 6.13 | 113 | Orange-brown |
| 3 | 342; 372 | 500; 800 | 2.24 | 310 | Orange-brown |
| 4 | 272; 350 | 475; 525; 775 | 6.42 | 108 | Blue-violet |
| 5 | 271; 352 | 475; 525; 775 | 9.12 | 76 | Blue-violet |
| 6 | 284; 362 | 475; 525; 800 | 4.03 | 172 | Blue-violet |
| Compound | R₁ | R₂ | R₃ | R₄ | R₅ |
| 1 | Cl | H | H | H | H |
| 2 | Br | H | H | H | H |
| 3 | H | COOCH₃ | H | H | H |
| 4 | Cl | H | H | H | N(CH₃)₂ |
| 5 | Br | H | H | H | N(CH₃)₂ |
| 6 | H | COOCH₃ | H | H | N(CH₃)₂ |

Naphthopyrans exhibit favorable properties for use as markers in ink compositions for continuous inkjet printing. For instance, naphthopyrans are thermally and photochemically stable in ink compositions, and do not degrade substantially during the printing (deposition) process. A deposited ink composition including naphthopyrans is also thermally and photochemically stable, able to withstand repeated activation cycles.

A photochromic ink composition may be used in any continuous inkjet printer known in the art. The continuous inkjet printer may deposit one or more ink compositions on a substrate (product or product packaging) during manufacturing, production, or packaging processes.

Activation of a marker in an ink composition may include irradiating a deposited ink composition (a mark) with electromagnetic radiation. For instance, activation of a marker in an ink composition may include irradiating a deposited ink composition with UV, visible, or IR radiation.

For example, activation of a naphthopyran by UV radiation induces a color change from clear to black. Activation of a naphthopyran in a visible inkjet ink composition (for instance, gray ink or black ink) induces a color change of the naphthopyran from clear to black without changing the appearance of the deposited ink composition. Authentication with a marker without a visually detectable change advantageously increases the difficulty of counterfeiting the mark.

Although activation of a desired photochromic compound in a visible ink composition is not visually detectable, a mark with the photochromic compound in the activated state absorbs more visible radiation than a mark with a photochromic compound that is not activated. Thus, activation of a mark with a visible photochromic compound results in a measurable change in the absorbance (and reflectance) of visible radiation. In an embodiment, a method of authenticating a mark printed by a continuous inkjet printer includes assessing an absorbance (or reflectance) of visible radiation after activation of the mark. For instance, a mark with a naphthopyran will have a higher absorbance (lower reflectance) of visible radiation after activation. Thus, a measurable change in absorbance (or reflectance) of visible radiation after activation of the mark may allow authentication of a product.

A method of authenticating a mark with a marker deposited by a continuous inkjet printer may include irradiating the mark with visible radiation a first time, assessing a first absorbance (or reflectance) of visible radiation by the mark, activating the mark, irradiating the mark with visible radiation a second time, and assessing a second absorbance (or reflectance) of visible radiation by the mark. The change in absorbance (or reflectance) of visible radiation may be compared with an expected change for a mark of a known ink composition including a visible ink and the marker.

In some embodiments, a chosen amount of time may be allowed to elapse between activation of the mark and irradiation of the mark with probing radiation (for instance, visible radiation). In some embodiments, absorbance (or reflectance) of the mark may be assessed more than once before (or after) activation of the mark. For instance, before (or after) activation of the mark, the mark may be irradiated with visible radiation and the absorbance (or reflectance) may be assessed two or more times at chosen intervals. In some embodiments, a time dependence of the absorbance (or reflectance) of visible radiation may be compared with an expected absorbance (or reflectance) of visible radiation by a mark of a known ink composition. In some embodiments, the rate of change of absorbance or reflectance of a marker in an ink composition (for instance, following activation or during relaxation) may be assessed and compared with a rate of change for a known mark or marker.

In other embodiments, a mark may be probed with UV or IR radiation after activation of the mark. That is, absorbance or reflectance of UV or IR radiation may be assessed after activation of the mark. In some embodiments, a deposited ink composition with a photochromic compound (for instance, a naphthopyran) will absorb less (reflect more) UV radiation in the activated state than in the unactivated state. The assessed absorbance or reflectance may be compared with expected values for a mark of known composition to authenticate a mark.

To reduce the amount of time required for authentication, it is desirable for a marker in a mark to return quickly to an unactivated state from an activated state. A marker with a short half-life will allow rapid authentication of a mark. The activated (colored) state of naphthopyrans described herein, for instance, has a half-life of about 5 seconds, allowing efficient probing of the mark for authenticity.

FIG. 1 depicts a schematic diagram of instrument 100 for assessing the authenticity of a mark. Instrument 100 may be a hand-held or portable instrument. Instrument 100 may be, for instance, similar in size and shape to a bar code reader. Instrument 100 includes one or more radiation sources 102, one or more detectors 104, and one or more processors 106. Instrument may include display 108 and/or data port 110 for exporting data.

Radiation source 104 may be a UV, visible, and/or IR radiation source. In some embodiments, a visible radiation source may be a white light source. Detector 104 may include, for instance, a photodiode or photomultiplier. With mark 112 on product 114 positioned proximate instrument 100 in, for example, ambient lighting conditions, the assessment cycle of the instrument may be initiated. Product 114 may be, for instance, a package of cigarettes. After authenticity of the mark has been assessed, a result may be sent to display 108 and/or sent to a data collection device via data port 110. The instrument may display, for example, a percentage change in absorbance or reflectance of visible radiation or a pass/fail indicator.

Processor 106 is configured to assess an amount of visible radiation absorbed by a mark on the product before and after activation of the mark by radiation source 102. A difference between the amount of visible radiation absorbed by mark 112 before and after activation of the mark is an indication of the authenticity of the mark.

### EXAMPLE

Photochromic stability of a photochromic black ink and an uncolored acetone analogue is in FIG. 2 (arbitrary units). Prints were made and then exposed to light in accordance with ISO 105-B02. The prints were partially masked and mounted in a megasol xenon arc lightfastness tester, along with a set of Blue Wool reference standards. The samples were exposed to accelerated artificial sunlight at a relative humidity of 40% and black panel temperature of 45° C. The tester incorporated the day/night mode (i.e., the samples were turned through 180° after rotation around the xenon lamp. The samples were then exposed for 25 hours (equivalent to Blue Wool 3), and remasked so that half the previously exposed area was now covered. The samples were then exposed for a further 25 hours (equivalent to Blue Wool 4).

The control (unexposed) samples are labelled 200 (black ink) and 202 (acetone). The additional samples were exposed for 25 and 50 hours. After 25 hours of exposure, the photochromic signal from the black ink 204 is unchanged; whereas the signal from the colorless ink 206 has dropped to about 5% of its initial value. Likewise, after 50 hours of exposure, the signal from the black ink 208 is around 25% of the original signal, whereas the signal from the colorless ink 210 has dropped to about 2.5% of its initial value.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An ink composition for use in continuous inkjet printing, comprising:
a) a visible ink;
b) a marker mixed with the visible ink to form the ink composition, wherein
i) the marker is stable in the ink composition;
ii) the marker is capable of being activated to an activated state after deposition of the ink composition onto a substrate by continuous inkjet printing, where the activated state has a half-life in the deposited ink composition of at most about 5 seconds;
iii) the marker in the deposited ink composition in the activated state has a reflectance of visible radiation that is measurably different than the reflectance of visible radiation of the marker in the deposited ink composition that is not activated; and
iv) the measurable change is not visually detectable by the human eye.

2. The ink composition of claim 1, wherein the marker is a visible marker.

3. The ink composition of claim 1, wherein the marker is a UV marker.

4. The ink composition of claim 1, wherein the marker is an IR marker.

5. A method of marking a product, comprising:
printing a mark on a product by depositing an ink composition with a continuous inkjet printer, wherein the ink composition comprises a visible ink and a marker mixed with the visible ink to form the ink composition, wherein
i) the marker is stable in the ink composition;
ii) the marker is capable of being activated to an activated state after deposition of the ink composition onto the product by continuous inkjet printing, where the activated state has a half-life in the deposited ink composition of at most about 5 seconds;
iii) the marker in the deposited ink composition in the activated state has a reflectance of visible radiation that is measurably different than the reflectance of visible radiation of the marker in the deposited ink composition that is not activated; and
iv) the measurable change is not visually detectable by the human eye.

6. The method of claim 5, wherein the marker is a visible marker.

7. The ink composition of claim 5, wherein the marker is a UV marker.

8. The ink composition of claim 5, wherein the marker is a IR marker.

9. A method of assessing authenticity of a product, comprising:
selecting a product with a mark;
assessing a first reflectance of a mark;
activating the mark;
assessing a second reflectance of the mark; and
comparing the first reflectance with the second reflectance to authenticate the product.

10. The method of claim 9, wherein the mark comprises a visible ink and a visible marker.

11. The method of claim 9, wherein the mark comprises a visible ink and a UV marker.

12. The method of claim 9, wherein the mark comprises a visible ink and a IR marker.

13. The method of claim 9, wherein activating the mark comprises irradiating the mark with electromagnetic radiation.

14. The method of claim 9, wherein activating the mark comprises irradiating the mark with white light.

15. The method of claim 9, wherein activating the mark comprises irradiating the mark with UV radiation.

16. The method of claim 9, wherein activating the mark does not induce a visible change in the mark.

17. The method of claim 9, wherein the first reflectance is greater than the second reflectance.

18. The method of claim 9, wherein the first reflectance and the second reflectance are assessed with a hand-held instrument.

19. A method of assessing authenticity of a product, comprising:
selecting a product with a mark;
irradiating the mark with visible radiation;
assessing a first absorbance of visible radiation by the mark;
activating the mark;
irradiating the mark with visible radiation;
assessing a second absorbance of visible radiation by the mark; and
assessing the authenticity of the product by comparing the first absorbance with the second absorbance.

20. The method of claim 19, wherein the mark comprises a visible ink and a marker.

21. A method of assessing authenticity of a product, comprising:
selecting a product with a mark;
irradiating the mark with visible radiation;
assessing a first reflectance of visible radiation by the mark;
activating the mark printed on the product;
irradiating the mark with visible radiation;
assessing a second reflectance of visible radiation by the mark;
allowing time to elapse;
irradiating the mark with visible radiation;
assessing a third reflectance of visible radiation by the mark;
comparing the reflectance of visible radiation by the mark as a function of elapsed time with an expected reflectance as a function of elapsed time for an authentic product.

22. The method of claim 21, wherein the mark is a bar code.

23. The method of claim 21, wherein the mark is a portion of a label.

24. The method of claim 21, wherein the mark is a logo.

25. The method of claim 21, wherein activating comprises irradiating with visible radiation.

26. The method of claim 21, wherein activating comprises irradiating with UV radiation.

27. The method of claim 21, wherein activating comprises irradiating with IR radiation.

28. A method, comprising:
selecting a product;
depositing an ink composition on at least a portion of the product with a continuous inkjet printer, wherein the ink composition comprises a visible ink and a marker;
assessing a first reflectance of a mark;
activating the mark;
assessing a second reflectance of the mark; and
comparing the first reflectance with the second reflectance.

29. The method of claim 28, wherein activating the mark comprises irradiating the mark with visible radiation.

30. The method of claim 28, wherein activating the mark comprises irradiating the mark with UV radiation.

31. The method of claim 28, wherein activating the mark comprises irradiating the mark with IR radiation.

32. A hand-held apparatus for authenticating a product, comprising:
a light source comprising visible radiation;
a detector; and
wherein the detector is configured to assess an amount of visible radiation reflected by a mark on a product before and after activation of the mark, wherein a difference between the amount of visible radiation reflected by the mark before activation of the mark and the amount of visible radiation reflected by the mark after activation of the mark allows assessment of the authenticity of the product.

33. The apparatus of claim 32, wherein the light source is a white light source.

34. A hand-held apparatus for authenticating a product, comprising:
a light source comprising visible radiation;
a detector;
wherein the detector is configured to assess an amount of visible radiation absorbed by a mark on the product before and after activation of the mark, wherein a difference between the amount of visible radiation absorbed by the mark before activation of the mark and the amount of visible radiation absorbed by the mark after activation of the mark is an indication of the authenticity of the mark.

35. The apparatus of claim 34, wherein the light source is a white light source.
